(19) United States
(12) Patent Application Publication
(10) Pub. No.: US 2005/0025288 A1
(43) Pub. Date: Feb. 3, 2005

(54) SYSTEM AND METHOD TO QUALIFY A LINE PAIR

(76) Inventor: Andrew Sachs, North Potomac, MD (US)

Correspondence Address: MOORE & VAN ALLEN PLLC, P.O. BOX 13706, Research Triangle Park, NC, 27709, US

(21) Appl. No.: 10/604,581

(22) Filed: Jul. 31, 2003

(51) Int. Cl. H04M 1/24; H04M 3/08; H04M 3/22

(52) U.S. Cl. 379/22.03; 379/29.01; 379/29.03

(57) ABSTRACT

A system and method to qualify a line pair by a single technician is disclosed. The method may include, sending an initiate test signal to a termination unit (HTU). The HTU may be a central office termination unit (HTU-C) at a telephone switching office or a remote termination unit (HTU-R) at a subscriber end of the line pair. The method may also include performing a series of line pair qualifying tests, wherein the HTU is adapted to provide selected types of terminations connectable to the line pair to perform the qualifying tests. The system involves using a termination unit (HTU) as a far-end device to selectively provide different types of terminations connectable to a line pair to perform the series of qualifying tests with a technician at only a testing end of the line pair.

### FIELD OF THE INVENTION

The present invention relates to high bit-rate, complex communications, such as high bit-rate digital subscriber line (DSL) technologies (ADSL, ADSL2+, HDSL2, G.SHDL) and the like, and more particularly to a system and method to qualify a line pair for such services or similar services.

### BACKGROUND OF INVENTION

High performance or high bit-rate (about 1.536 Mbps or higher) communication services, such as complex DSL technologies and the like, are typically being deployed over standard telephone local loops or copper line pairs originally designed for voice telecommunication services and are being expected to “get the most out of a loop.” These technologies rely heavily on error correction, complex modulation schemes, scrambling and other adaptive techniques to carry close to the theoretical maximum traffic on a local loop. These complex DSL technologies may be serving mission critical applications. Not just someone surfing the Internet. HDSL and increasingly, ADSL are being used by businesses for day-to-day operations, e-commerce and the like and therefore have demanding uptime requirements. Circuit downtime may be a minimum of about a thirty second event. The adaptive nature of the modems used in such circuits or communication systems means there may be about a thirty second training period if a link fails for the modem to recharacterize the line. This may be a significant outage and may cause some telephone or data systems to go into an alarm status. Accordingly, full copper or line qualification testing may be paramount to achieving the reliability from such systems.

Testing and qualifying these line pairs can require at least two technicians or multiple trips by a single technician between a subscriber's or customer's premises and a serving telephone switching office or central office. One technician with a test set may be located at the subscriber's premises. The other technician may be located at the serving telephone central office to attach a portable tester, such as a far-end device (FED) or the like to the line pair. The FED may operate in coordination with the one technician's test set to apply different types of terminations to the line pair to test and qualify the line pair for xDSL service or similar service. Under some circumstances, where the telephone central office may be manned, the cooperation of a frame attendant or other personnel at the telephone central office may be employed. Although, this arrangement can be time consuming and inefficient because of delays waiting for assistance from the central office personnel who may not have the proper equipment and may be busy with other demands. Alternatively, a technician can visit the telephone central office to install the portable tester, FED or the like.

Therefore, line testing and qualifying or copper testing and qualifying can be labor intensive and costly. With profit margins for some xDSL services declining, some service providers have opted not to perform line qualification testing. Additionally, some modems used for xDSL service have been touted to be able to detect faults on the line pair that may lead to future system failures. Such modems may be able to effectively quantify random errors but may fail to detect faults that can make the line pair susceptible to non-random events, such as imbalance and other impairments.

Accordingly, there is a need to provide a method and system to qualify a line pair that is efficient, cost effective and only requires a single technician. There is also a need to provide a test set with a modem that is capable of instructing or sending signals to an HTU or modem at another end of the line pair to perform line pair qualification testing.

### SUMMARY OF INVENTION

In accordance with an embodiment of the present invention, a method to qualify a line pair may include sending an initiate test signal to a central office termination unit (HTU-C) or modem. A series of line pair qualifying tests may be performed in response to the initiate test signal, wherein the HTU-C or modem may be adapted to provide selected types of terminations connectable to the line pair to perform the qualifying tests.

In accordance with another embodiment of the present invention, a method to qualify a line pair may include coupling a test set adapted to perform a series of qualification tests to a line pair. The method may also include using a terminating unit (HTU) or modem as a far-end device to perform the series of qualification tests in coordination with the test set.

In accordance with another embodiment of the present invention, a method to qualify a line pair may include coupling a far end device to the line pair to perform selected line qualification tests. The method may also include coupling a termination unit to the line pair by the far end device to perform other selected line qualification test.

In accordance with another embodiment of the present invention, a system to qualify a line pair may include a test set adapted to perform a series of qualification tests on the line pair. The system may also include a terminating unit (HTU) or modem that may be adapted to selectively provide different types of terminations connectable to the line pair to perform the series of qualifying tests on the line pair.

In accordance with another embodiment of the present invention, a system to qualify a line pair may include a far end device to perform line qualification tests and a termination unit. The far end device may be adapted or programmed to connect the termination unit to the line pair to perform the line qualifications tests.

In accordance with another embodiment of the present invention, a termination unit (HTU) or modem may include a set of switches. The HTU or modem may also include a microprocessor to operate the switches to selectively connect different types of terminations to a line pair to perform qualifying tests on the line pair.

In accordance with another embodiment of the present invention, a test set to qualify a line pair may include a microprocessor to perform line qualification tests. An xDSL type modem may be included to signal a termination unit (HTU) or modem to selectively connect different types of terminations to the line pair to perform the line qualifying tests.

In accordance with another embodiment of the present invention, a method of making a termination unit (HTU) or modem may include providing a microprocessor; and providing instructions executable by the microprocessor to perform line qualification tests on a line pair.

### BRIEF DESCRIPTION OF DRAWINGS

FIG. 1 is a block diagram of a system to qualify a line pair in accordance with an embodiment of the present invention.

FIG. 2 is a block diagram of a system to qualify a line pair in accordance with another embodiment of the present invention.

FIG. 3 is a block diagram of a system to qualify a line pair in accordance with another embodiment of the present invention.

FIG. 4 is flow chart of a method to qualify a line pair in accordance with an embodiment of the present invention.

FIG. 5 is a flow chart of a method to qualify a line pair in accordance with another embodiment of the present invention.

FIG. 6 is a flow chart of a method to qualify a line pair in accordance with a further embodiment of the present invention.

### DESCRIPTION OF INVENTION

The following detailed description of preferred embodiments refers to the accompanying drawings that illustrate specific embodiments of the invention. Other embodiments having different structures and operations do not depart from the scope of the present invention.

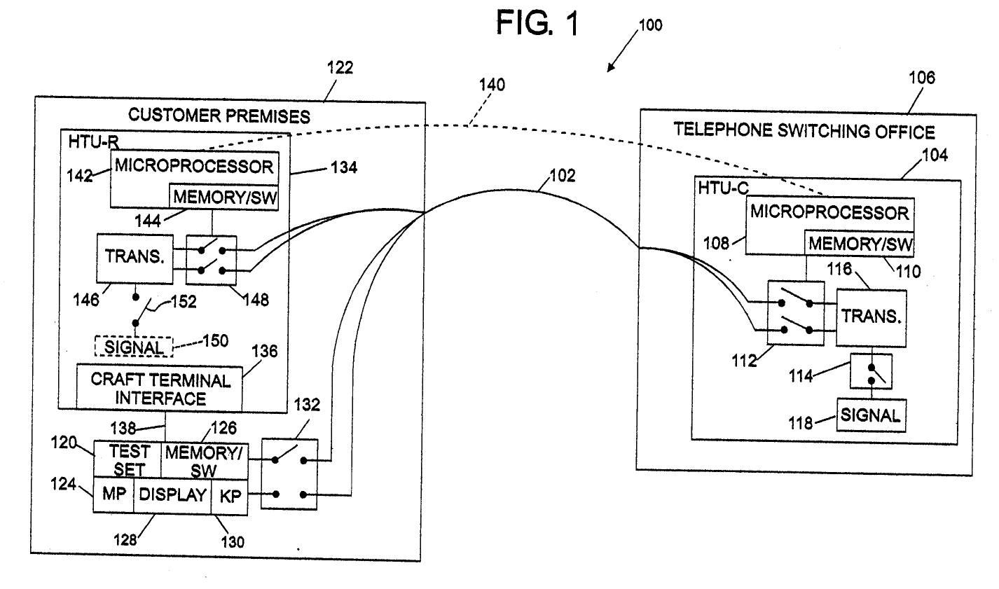

FIG. 1 is a block diagram of a system 100 to qualify a line pair or pairs 102 for xDSL service or similar communication service in accordance with an embodiment of the present invention. The system 100 may include a central office termination unit (HTU-C) 104, modem or the like located at a telephone switching office 106 or central office. The HTU-C 104 or modem may be adapted to selectively provide different types of terminations connectable to the line pair 102 to perform qualifying tests on the line pair 102 for xDSL or similar service. The HTU-C 104 may include a microprocessor 108, controller or similar device. The HTU-C 104 may also include a memory 110 that may contain software or stored computer programs that may be executed by the microprocessor 104 to control operation of the HTU-C 104 including performance of line qualification tests. The memory 110 may be part of the microprocessor 104 or a separate component.

The HTU-C 104 may also include a set of switches 112 and 114, relays or similar devices. The microprocessor 108 may operate the switches 112 and 114 in response to receiving predetermined signals to selectively connect different types of terminations, such as an open circuit, a short circuit and a selected signal or the like, to the line pair 102 for line qualification or copper qualification testing. A first set of switches 112 may connect the line pair 102 to a transformer 116. Accordingly, the microprocessor 108 may operate the switches 112 to an open position, as shown in FIG. 1, to provide an open circuit termination to the line pair 102. The open circuit termination may be provided for a predetermined time period or in response to the HTU-C 104 receiving a first predetermined signal for performance of open circuit line qualifying tests, as will be described in more detail below. Alternatively, the microprocessor 108 may operate the switches 112 to a closed position to connect the line pair 102 to the transformer 116 and thereby provide a short circuit termination to the line pair 102. The short circuit termination may be coupled to the line pair 102 for a predetermined time period or in response to the HTU-C 104 receiving a second predetermined signal for performance of short circuit line qualifying tests, as described in more detail below.

The transformer 116 may be connectable to a signal source 118 by a second switch 114, relay or similar device. The signal source 118 may be the source of a signal with known characteristics for measuring or performing signal loop line qualification tests on the line pair 102. The microprocessor 104 may operate switches 112 and switch 114 to couple the signal source termination 118 to the line pair 102. The signal source termination 118 may be coupled to the line pair 102 for a predetermined time period or in response to the HTU-C 104 receiving a third predetermined signal for performing signal loop line qualification tests as described in more detail below.

The system 100 may also include a test set 120 that may be used at a customer's or subscriber's premises 122. The test set 120 may be an Acterna® model HST-3000™ handheld outside plant tester as manufactured by the Acterna Corporation, Germantown, Md., or a similar type testing device. The test set 120 may include a microprocessor (MP) 124 to control operation of the test set 120 and to perform different tests, such as line qualification tests on line pair 102. The test set 120 may also include a memory 126 to store software (SW) or computer programs for operation of the test set 120. The memory 126 may also store application programs to perform specific functions or tests. For example, line or copper qualification tests that may include generating predetermined signals to instruct the HTU-C 104 to initiate the line qualification tests or to connect a selected termination to the line pair 102 in response to receiving each of the predetermined signals. The memory 126 may also store results of different line qualification tests or results of other types of tests. The test set 120 may also include a display 128 and keypad (KP) 130 for a user or technician to interface with the test set 120 and control the test set's operation. The test set 120 may be connected to the line pair 102 by a set of switches 132, relays, jacks or similar devices.

The test set 120 may be connected to a remote termination unit (HTU-R) 134. The test set 120 may be connected to a craft terminal interface 136 of the HTU-R 134 by a video terminal 100 (VT100) emulation represented by reference numeral 138. The test set 120 may communicate with the HTU-C 104 through the HTU-R 134 and over a digital subscriber line (xDSL) link, such as an embedded operations channel (EOC) or the like, as represented by the broken or dashed line 140 in FIG. 1. The EOC 140 may reside on the line pair 102. In an alternate embodiment, the test set 120 may communicate or send signals to the HTU-C 104 via a non-DSL link, such as analog signals or the like over the line pair 102.

The HTU-R 134 may include a microprocessor 142, controller or similar apparatus to control operation of the HTU-R 134. A memory 144 or storage device may be associated with the microprocessor 142 to store software (SW) or computer programs to be executed by the microprocessor 142 for operation of the HTU-R 134. The memory 144 or storage device may be incorporated as part of the microprocessor 142, as shown in FIG. 1, or may be a separate component. The HTU-R 134 may also include a transformer 146. The transformer 146 may be coupled to the line pair 102 by a set of switches 148, relays or the like, under control of the microprocessor 142. The HTU-R 134 may be connected to the line pair 102 for the test set 120 to send signals to the HTU-C 104 over the xDSL link or EOC 140 to conduct the line qualification tests or other tests. The HTU-R 134 may be automatically disconnected from the line pair 102 by the switches 148 under control of the microprocessor 142 as instructed by the test set 120. The test set 120 may be automatically connected to the line pair 102 by the switches 132 to conduct the desired line qualification tests.

In one embodiment of the present invention, the switches 148 and 132 may be automatically operated to alternately connect and disconnect the HTU-R 134 and the test set 120 to the line pair 102 to conduct the line qualification tests. For example, the test set 120 may be coupled to the HTU-C 104 by the HTU-R 134 to send a predetermined signal to the HTU-C 104 via the xDSL link or EOC 140 for the HTU-C 104 to connect a selected termination to the line pair 102. After sending the predetermined signal, the switches 148 may be automatically operated to disconnect the HTU-R 134 from the line pair 102. The switches 132 may be automatically operated to connect the test set 120 to the line pair 102 to perform a selected one of a plurality of line qualification tests. Alternately connecting and disconnecting the HTU-R 134 and the test set 120 to the line pair 102 may be repeated to instruct the HTU-C 104 to couple different terminations to the line pair 102 while the test set 120 performs different ones of the plurality of line qualification tests. In another embodiment, the switches 148 and 132 may be manually operated or operated by a technician entering an instruction or code into the keypad 130 of the test set 120. Accordingly, the present invention permits a line pair or pairs, such as line pairs 102, to be tested by a single technician from the customer's premises 122.

While the present invention has been described with respect to the test set 120 testing the line pair 102 from the customer premises 122, the test set 120 could also test the line pair 102 from the switching office 106. In this embodiment, the HTU-R 134 or modem may be modified to apply the different types of terminations to the line pair for the line qualification testing. The HTU-R 134 may be modified to include a signal source 150 connectable to the transformer 146 by a switch 152, relay or the like. The signal source 150 and switch 152 are shown in dashed or broken lines in FIG. 1 to illustrate that these components may form another embodiment of the present invention. The software 144 of the HTU-R 134 may also be modified to control the operation of the HTU-R 134 to connect different types of terminations to the line pair 102 similar to that described above with respect to HTU-C 104 to conduct the qualification testing. Accordingly, the present invention permits a line pair or pairs to be tested by a single technician, and in one embodiment of the present invention, line qualification testing can be done from the telephone or central office 106 without a technician being required to visit the customer premises 122.

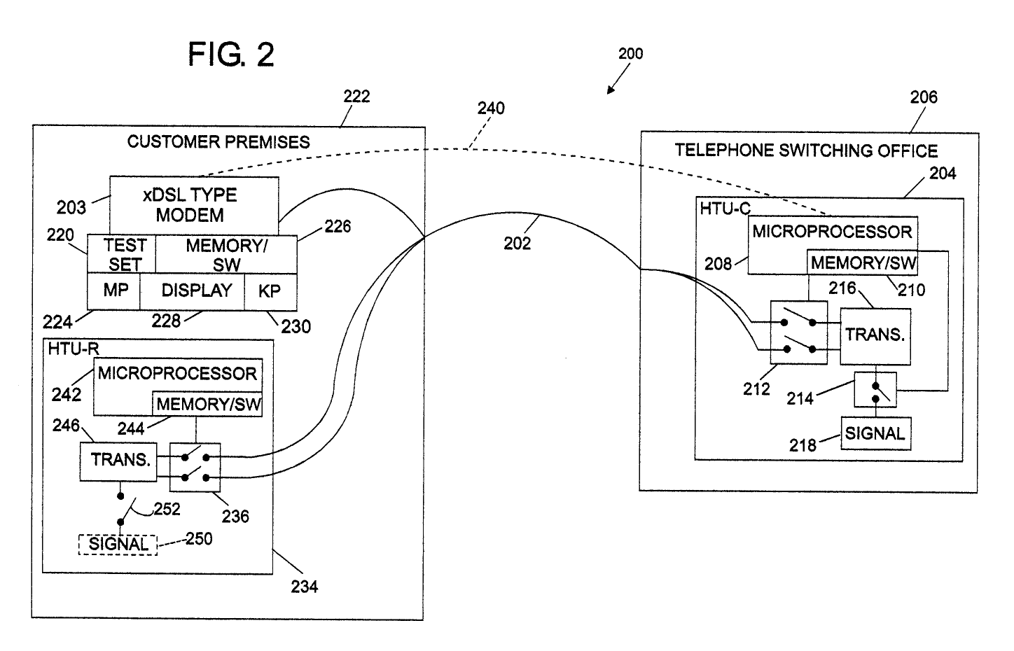

FIG. 2 is a block diagram of a system 200 to qualify a line pair 202 in accordance with another embodiment of the present invention. The system 200 may be similar to the system 100 of FIG. 1. However, the system 200 may include an xDSL type modem 203 or a similar apparatus associated with the test set 220. The xDSL type modem 203 may be used in place of a remote termination unit (HTU-R) 234 to communicate or send signals to a central office termination unit (HTU-C) 204 or modem in a telephone switching or central office 206 for performing the line qualification tests. The xDSL type modem 203 may be integrated into the test set 220 or may be a separate component.

The HTU-C 204 may include a microprocessor 208, controller or similar device to control operation of the HTU-C 204. A memory 210 or storage device may be associated with the HTU-C 204 to store software or computer executable code or programs for execution by the microprocessor 208 to carry out various functions that may include performing the line qualification tests in coordination with the test set 220. The HTU-C 204 may include a set of switches 212 and 214 or similar devices that may be controlled by the microprocessor 208 to couple different types of terminations to the line pair 202 for different line qualification tests. A first set of switches 212 may couple the line pair 202 to a transformer 216. The switches 212 and 214 may then be operated under control of the microprocessor 204 to connect different types of terminations to the line pair 202 for line qualification testing similar to that described with respect to FIG. 1.

The test set 220 may include a microprocessor 224, controller or the like to control operation of the test set 220. The test set 220 may also include a memory 226 or storage device to store software or computer executable instructions or programs that may be executed by the microprocessor 224 to perform the line qualification tests and other functions. The test set 220 may further include a display 228 and keypad 230 for a technician to interface with the test set 220 and control the test set's operation. As previously discussed, an xDSL type modem 203 may be associated with the test set 220 as a separate component or integrated into the test set 220. The modem 203 may be used to communicate with the HTU-C 204 via an xDSL link or EOC 240. The EOC 240 may be a channel on the line pair 202. The test set 220 and modem 203 may also communicate with the HTU-C 204 over a non-xDSL link, such as over the line pair 202.

A remote termination unit (HTU-R) 234 or modem may be installed at the customer premises 222. However, the HTU-R 234 may not be needed in the embodiment shown in FIG. 2 because the test set 220 may include the modem 203 as an integrated or separate component. If the HTU-R 234 is installed, it may be disconnected from the line pair 202 during line qualification testing by a set of switches 236 or similar devices. The HTU-R 234 may include a microprocessor 242 to control operation of the HTU-R 234 and a memory 244 to store software or computer programs for execution by the microprocessor 242. The HTU-R 234 may also include a transformer 246.

In one embodiment of the present invention a signal source 250 may be connected to the transformer 246 by a switch 252. The switches 236 and 252 and the signal source 250 enable the HTU-R 234 to function as an FED or the like to test the line pair 202 from the telephone switching office 206 similar to that described with respect to FIG. 1.

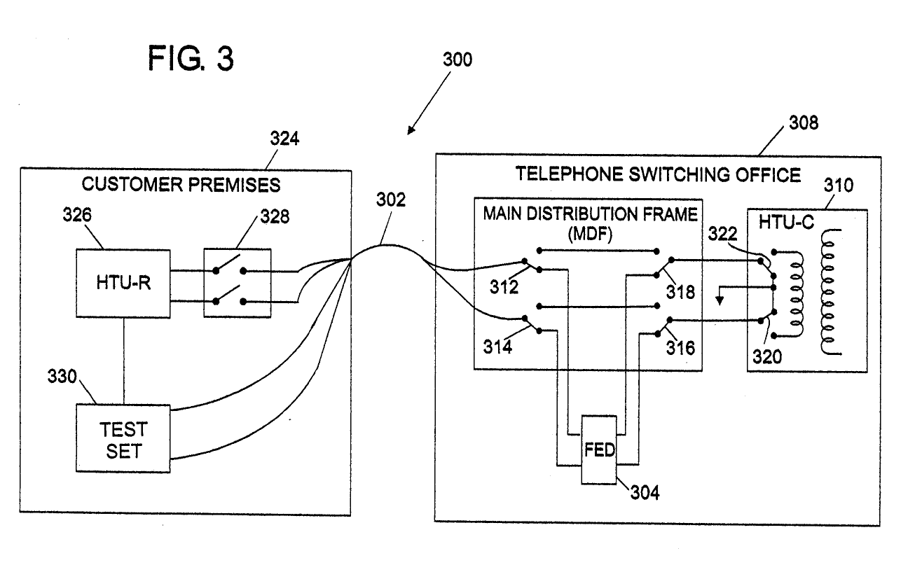

FIG. 3 is a block diagram of a system 300 to qualify a line pair 302 for DSL, xDSL service or the like in accordance with another embodiment of the present invention. The system 300 may include a far end device (FED) 304 or the like that may be coupled to a main distribution frame (MDF) 306 in the telephone switching office 308 or central office. The FED 304 may be located in a repeater bay of the switching office 308. The FED 304 may be any device to apply different terminations to a line pair, such as an open circuit, a short circuit, a predetermined signal or the like. The FED 304 may be connectable to a central office termination unit (HTU-C) 310 when needed during the line qualification testing process by operation of switches or relays 312-322. The FED 304 may be a card or circuit board to permit the copper or line qualification testing of line 302 by a single technician at a customer premises 324. A remote termination unit (HTU-R) 326 may be disconnected from the line 302 by switches or relays 328 and a test set 330 may be connected to the line 302 to qualify the line for xDSL operation or the like. The test set 330 may be similar to the test set 120 described with respect to in FIG. 1. The HTU-C 310 and FED 304 may each include a microprocessor similar to the microprocessor 108 described with respect to FIG. 1. The HTU-C and FED 304 may be programmed to operate in coordination with the copper test set 330 to test the line pair 302 only from the customer premises 324 without the need of assistance from personnel at the telephone switching office 308 or the need to make trips to the switching office 308 to connect and retrieve an FED or the like. With the HTU-C 310 programmed to perform the line qualification testing in coordination with the test set 330 the following tests may be performed: AC/DC foreign voltage, insulation resistance/leakage, capacitive length/balance, load coil detection, longitudinal balance power influence, TDR, wideband noise, insertion loss/slope/loop attenuation (spectral line characterization), metallic impulse noise, return loss and the like. Loop resistance may also be tested with some test compatible HTU-C devices. With the FED 304 the following tests may also be performed: loop resistance (for all manufacturers and models of equipment), longitudinal impulse noise, TDR, return loss from both ends and similar test.

In one embodiment of the present invention, a common ground connection 324 may be coupled to the input relays or switches 320 and 322 on the HTU-C card or circuit board 310. This may permit resistive balance testing of the line 302 without the need for another tester or person in the switching office 308.

As previously discussed, the FED 304 under direction of signals from the test set 330 may couple the line 302 to the HTU-C 310 when needed for some span or line qualification tests. Because the FED 304 may allow the copper testing and ‘pass-through’ to the HTU-C 310 substantially all copper, HDSL, T1 and similar tests on the line 302 may be performed automatically.

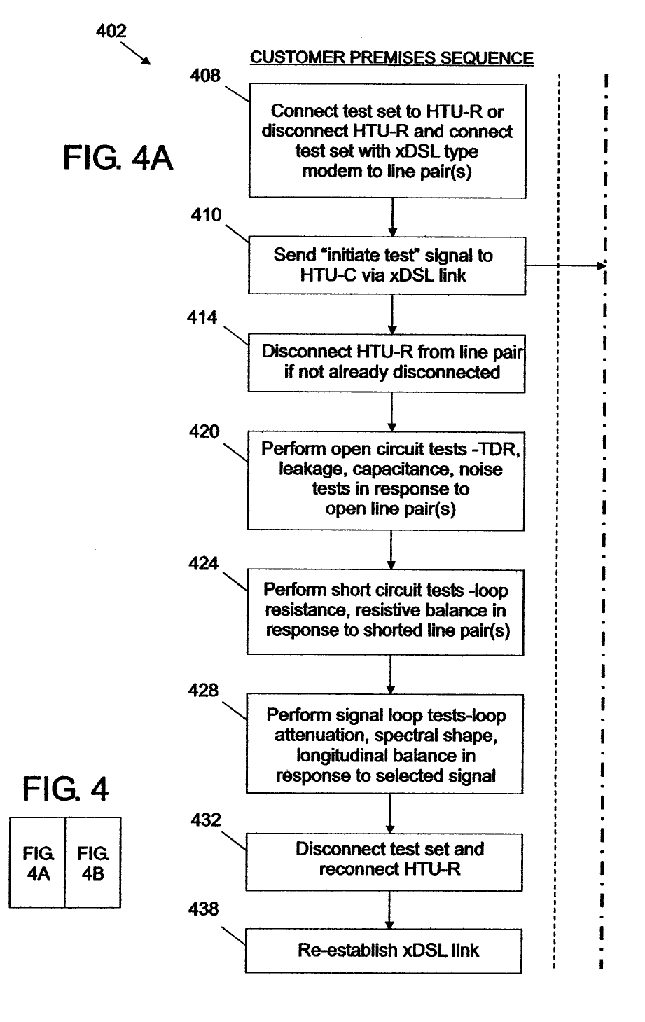

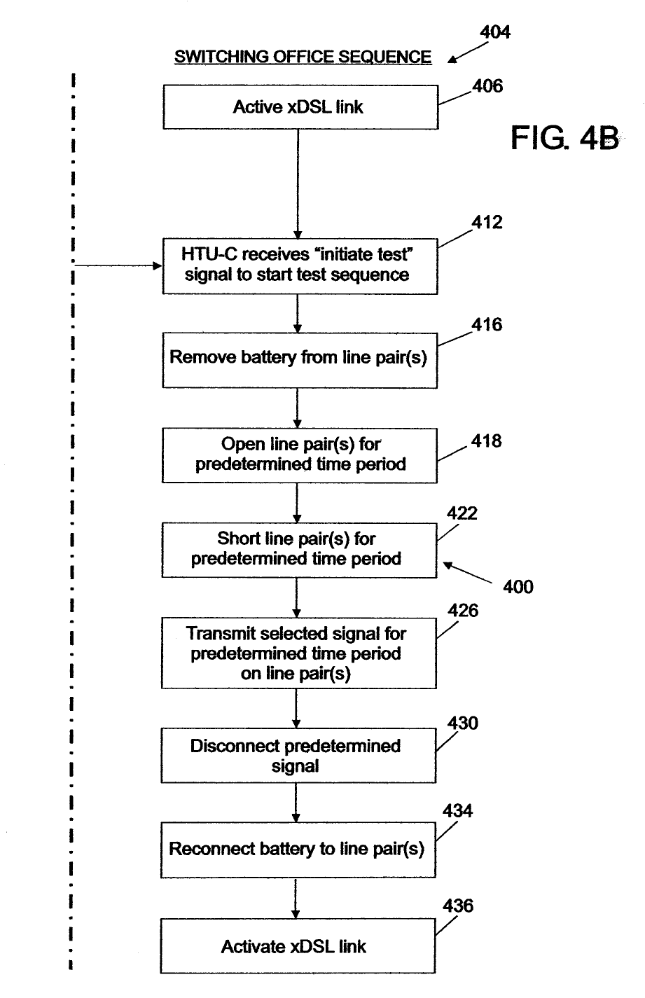

Examples of different methods of operation of the exemplary embodiments illustrated in FIGS. 1, 2 and 3 will now be described with reference to FIGS. 4, 5 and 6. FIG. 4 is flow chart of a method 400 to qualify a line pair, such as line pair 102, 202 or 302 of FIGS. 1, 2 or 3 respectively in accordance with an embodiment of the present invention. The method 400 may include a customer premises sequence 402 of actions or events and a telephone switching office or central office sequence 404 of actions or events. An xDSL link or the like may be active in block 406. In block 408, a test set similar to test set 120 of FIG. 1 may be connected to a termination unit (HTU-R) similar to HTU-R 120. In an alternative embodiment, an HTU-R similar to HTU-R 234 (FIG. 2) may be disconnected from the line pair and a test set with an xDSL modem similar to test set 220 and modem 203 may be connected to the line pair 202. As previously described, the modem 203 may be integrally formed as part of the test set 220. In block 410, an “initiate test” signal may be sent to the HTU-C, such as HTU-C 104, 204 or 310 in FIGS. 1, 2 and 3 respectively, via an xDSL link 140 or 240, such as a embedded operations channel (EOC) or the like. In block 412, the HTU-C receives the “initiate test” signal that instructs the HTU-C to start the test sequence. As previously described, the HTU-C may be adapted or programmed to provide selected types of terminations connectable to the line pair to perform the line qualifying tests. The selected types of terminations may include an open circuit, a short circuit and a signal source capable of transmitting a signal of known characteristics on the line pair for testing by the test set at the other end of the line pair. In block 414, the HTU-R may be disconnected from the line pair automatically or manually by a technician, if the HTU-R is not already disconnected from the line pair in block 408.

In block 416, battery may be removed from the line pair or pairs to be tested and the line pairs may be opened for a predetermined period of time by the HTU-C in block 418. As previously described with respect to FIGS. 1 and 2, the line pair 102 or 202 may be open circuited or terminated by an open by the HTU-C operating switches 112 (FIG. 1) or 212 (FIG. 2) to an open position. In block 420, open circuit line qualifying tests may be performed by the test set located at the customer's premises in response to the open line pair or pairs. The open circuit line qualifying tests may include time domain reflectometer (TDR) tests or measurements, signal leakage tests or measurements, capacitance measurements and noise tests.

In block 422, the line pair or pairs may be short circuited or terminated by a short circuit by the HTU-C for a predetermined time period. As previously discussed with respect to FIGS. 1 and 2, the line pair 102 or 202 may be connected to the transformer 116 (FIG. 1) or 216 (FIG. 2) to provide a short circuit termination through the coils of the transformer 116 or 216. In block 424, short circuit line qualifying tests may be performed on the line pair or pairs by the test set at the customer premises in response to the short circuit termination. The short circuit tests may include loop resistance measurements and resistive balance tests or measurements.

In block 426, the HTU-C may connect the line pair or pairs to a signal source to transmit a selected signal for a predetermined time period on the line pair or pairs. As previously discussed with respect to FIGS. 1, the HTU-C 104 may be adapted or programmed to operate switches 112 and 114 to connect the signal source 118 to the line pair 102 to transmit a predetermined signal on the line pair 102. Similarly, in FIG. 2, the HTU-C 204 may be adapted or programmed to operate switches 212 and 214 to connect the signal source 218 to the line pair 202 to transmit a predetermined signal on the line pair 202. In block 428, signal loop tests may be performed on the line pair by the test set in response to the selected signal being transmitted on the line pair or pairs. The signal loop test may include loop attenuation tests, spectral shape measurements, and longitudinal balance measurements.

In block 430, the predetermined signal may be disconnected from the line pair or pairs by the HTU-C. In block 432, the test set may be disconnected from the line pair or pairs and the HTU-R may be reconnected to the line pair. The battery may be reconnected to the line pair or pairs in block 434 and the xDSL link may be activated in block 436. The xDSL link may then be re-established between the customer premises and switching office in block 438.

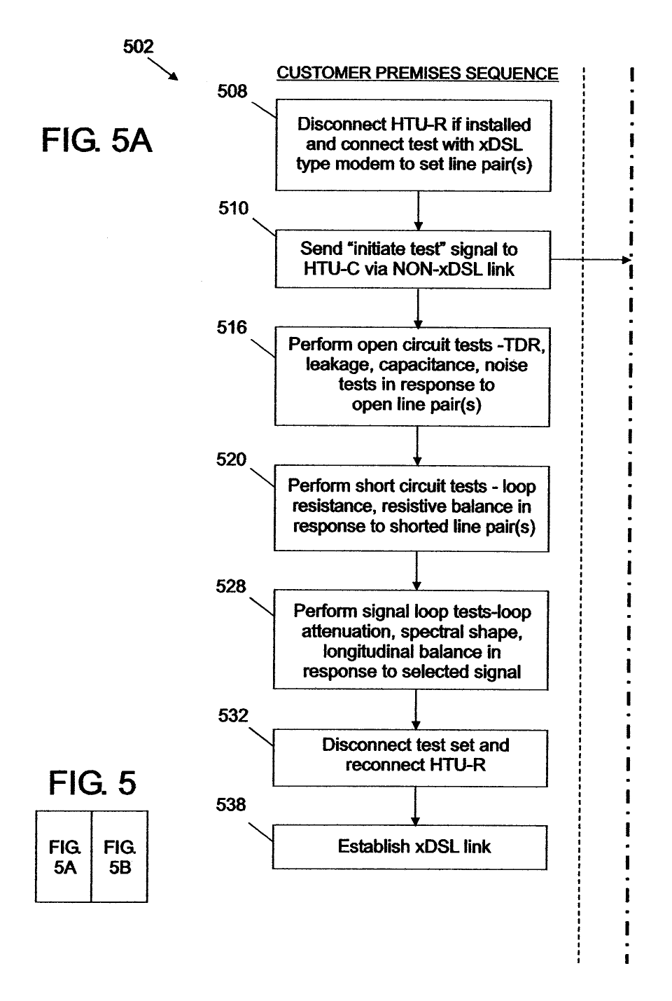

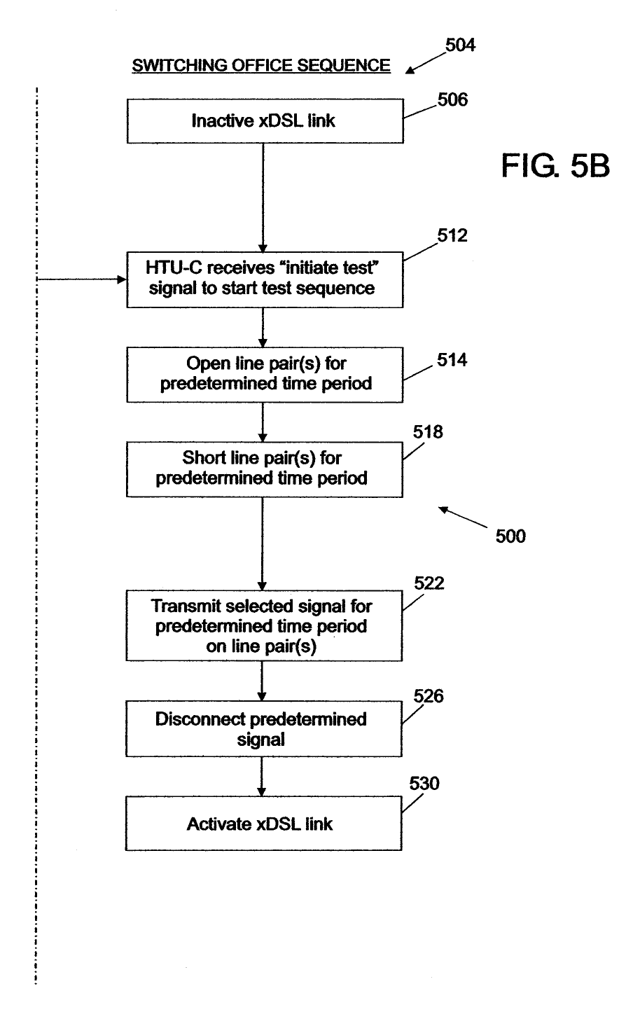

FIG. 5 is a flow chart of a method 500 to qualify a line pair in accordance with another embodiment of the present invention. The method 500 includes a sequence 502 of actions or events that occur at a customer's premises and a sequence 504 of actions or events that occur at a telephone switching office or central office. In block 506, the xDSL link may be inactive. In block 508, an HTU-R may be disconnected from the line pair, if installed, and a test set with an xDSL type modem may be connected to the line pair. An “initiate test” signal may be sent from the test set to the HTU-C via a non-xDSL link, such as the line pair, in block 510. In block 512, the HTU-C may receive the “initiate test” signal to start the test sequence.

In block 514, the line pair may be open circuited for a predetermined time period. The line pair may be open circuited by the HTU-C as previously described with respect to FIGS. 1 and 2. In block 516, open circuit line qualification tests may be performed on the line pair by the test set similar to that previously described. In block 518, the line pair may be shorted for a predetermined time period by the HTU-C similar to that previously described. Short circuit tests may be performed on the line pair by the test set in block 520.

In block 522, the line pair may be terminated by a signal source to transmit a selected signal for a predetermined time period on the line pair. While the predetermined signal is being transmitted on the line pair, signal loop tests may be performed on the line pair in block 528. The signal loop test may be conducted by the test set similar to that previously described. The test set may be disconnected from the line pair and the HTU-R may be reconnected or installed in block 532. The xDSL link may be activated in block 530 and the xDSL link between the customer premises and the switching office may be established in block 538.

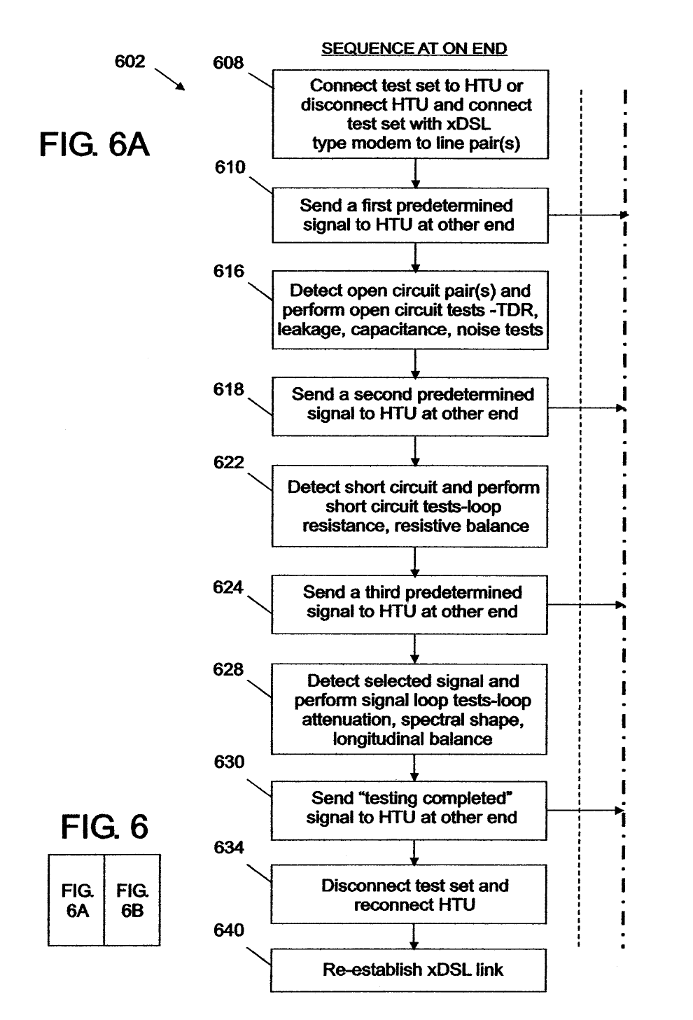

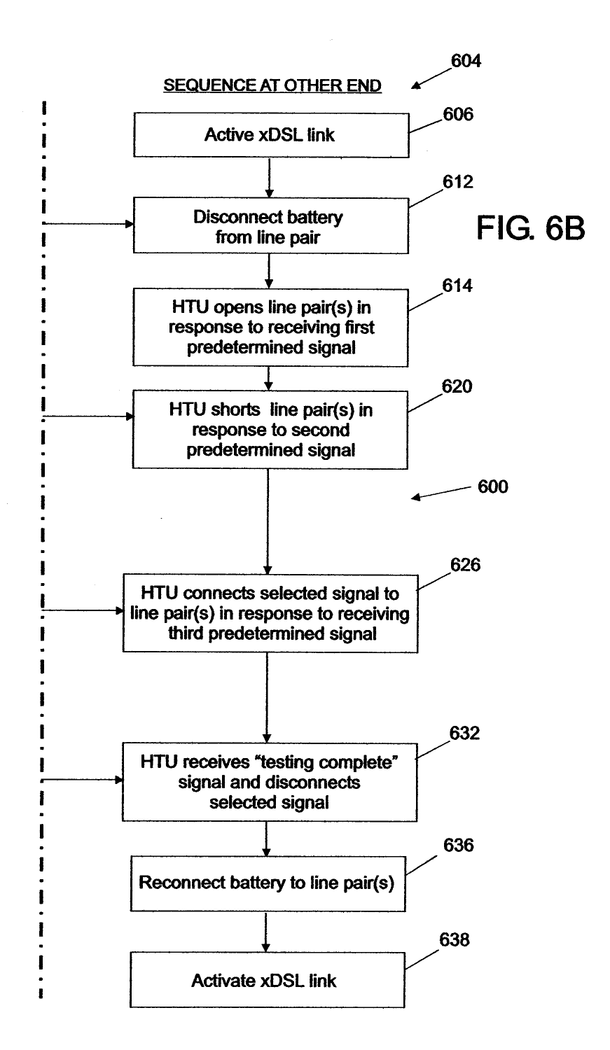

FIG. 6 is a flow chart of a method 600 to qualify a line pair in accordance with a further embodiment of the present invention. In method 600, the test set may be located at either end of the line pair or pairs and the termination unit (HTU), modem or similar device at the other end may be adapted or programmed to provide the selected terminations to conduct the line qualification tests. Similarly, the methods described with respect the FIGS. 4 and 5 may be modified so that the test set may perform the line qualification tests from either the customer premises or the telephone switching office. The HTU-R, remote modem or similar device may be modified to provide the appropriate terminations to conduct the line qualification tests from the telephone switching office.

The method 600 may include a sequence 602 of actions or events that occur at one end of a line pair or pairs and another sequence 604 of actions or events that occur at the other end of the line pair or pairs. Block 606 assumes that an xDSL link may be active between the one end and the other end of the line pair. Although the xDSL link may also be inactive or not yet installed. In block 608, a test set may be connected to an HTU, modem or similar device at one end of the line pair or pairs. In an alternate embodiment, the HTU or modem, if installed, may be disconnected from the line pair and a test set with an associated xDSL modem or the like may be connected to the line pair. The modem may be integrally formed with the test set or may be a separate component.

In block 610, a first predetermined signal may be sent to the HTU at the other end of the line pair. The test set may be adapted or programmed to send the first predetermined signal in response to a technician entering a code or instruction into the test set. The signal may be sent over an xDSL link, such as an EOC, or the signal may be sent over a non-xDSL link, such as the line pair, and may be an analog signal. In block 612, battery or power may be disconnected from the line pair if the xDSL link is active in block 606 in response to the first predetermined signal or another signal. The battery may be disconnected from the line pair by the HTU or modem at the other end of the line pair in response to the HTU receiving the first predetermined signal or the other signal if battery is connected to the line pair. A microprocessor in the HTU may be adapted or programmed to disconnect the battery by operating switches or relays similar to that previously described.

The HTU at the other end of the line pair may open the line pair or connect an open circuit termination to the line pair in response to receiving the first predetermined signal in block 614. A microprocessor in the HTU may cause switches to operate similar to that previously described to open the line pair. In block 616, the test set may detect the open line pair and begin to perform open circuit line qualifying tests on the line pair. Alternatively, the test set may be programmed to begin the open circuit line tests a chosen time delay after sending the first predetermined signal to provide the HTU at the other end adequate time to open circuit the line pair.

A second predetermined signal may be sent to the HTU at the other end of the line pair in block 618. The test set may be adapted or programmed to also send the second predetermined signal automatically after performing the open circuit line tests. In an alternate embodiment, a technician may enter a code or the like into the test set to send the second predetermined signal. The HTU at the other end of the line pair may be programmed to short the line pair or to connect the line pair to a short circuit termination in response to receiving the second predetermined signal. The microprocessor in the HTU may be programmed to operate switches to connect the line pair to a transformer to provide the short circuit termination as previously described. In block 622, the short circuit may be detected by the test set at the one end and the test set may begin to perform short circuit line qualification tests in response to detecting the short circuit on the line pair. In an alternative embodiment, the test set may be programmed to begin the short circuit line tests a chosen time period after sending the second predetermined signal to provide the HTU at the other end of the line pair adequate time to short circuit the line pair.

After performing the short circuit line test, the test set may be programmed to automatically send a third predetermined signal to the HTU at the other end in block 624. In an alternate embodiment, a technician may enter a code or the like to cause the test set to send the third predetermined signal. The HTU at the other end of the line pair may be programmed to automatically connect the line pair to a selected signal or source of a selected signal in response to receiving the third predetermined signal in block 626. In block 628, the test set may be programmed to detect the selected signal and to perform signal loop qualifying tests on the line pair. Alternatively, the test set may be programmed to automatically start performing the signal loop tests a chosen time period after sending the third predetermined signal to provide time for the HTU at the other end to connect the line pair to the source of the selected signal. The line pair may be connected to the signal source by the microprocessor in the HTU causing switches or relays to operated similar to that previously described.

In block 630, the test set may send a “test complete” signal to the HTU at the other end of the line pair. The test set may be programmed to automatically send the “test complete” signal when all qualification tests are completed or the technician may enter a code or message into the test set to cause the “test complete” signal to be sent. The HTU may be programmed to disconnect the selected signal from the line pair in response to receiving the “test complete” signal in block 632. In block 634, the test set may be disconnected from the line pair and the HTU at the one end may be reconnected to the line pair or installed. Battery may be reconnected to the line pair in block 636. The battery may be reconnected automatically by the HTU operating switches or the like in response to the HTU receiving the “test complete” signal. The xDSL link may be activated in block 638 and the link re-established or established for the first time between the one end and the other end in block 640.

Accordingly, the present invention permits line qualification testing by a single technician from only one end of the line pair. Thus multiple trips between a telephone central office and a customer's premises by a technician are eliminated by the present invention. Additionally, the need for more than one person or cooperation from personnel at a telephone central office is also eliminated by the present invention.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

1. A method to qualify a line pair, comprising:
sending an initiate test signal to a termination unit; and
performing a series of line pair qualifying tests, wherein the termination unit is adapted to provide selected types of terminations connectable to the line pair to perform the qualifying tests.

2. The method of claim 1, wherein performing the series of line tests comprises:
open circuiting the line pair for a predetermined time period or in response to receiving a predetermined signal; and
performing open circuit line tests while the line pair is open circuited by the termination unit.

3. The method of claim 2, wherein performing the open circuit line tests comprises performing at least time domain reflectometer tests, a signal leakage test, capacitive measurements, noise tests, a foreign voltage presence test, and an insulation resistance test.

4. The method of claim 1, wherein performing the series of line tests comprises:
short circuiting the line pair for a predetermined time period or in response to receiving a predetermined signal; and
performing short circuit line tests while the line pair is short circuited by the termination unit.

5. The method of claim 4, wherein performing the short circuit line test comprises performing at least a loop resistance measurement, ambient noise measurement, and a resistive balance test.

6. The method of claim 1, wherein performing the series of line tests comprises:
transmitting a selected signal on the line pair for a predetermined time period or in response to receiving a predetermined signal; and
performing signal loop tests while the selected signal is transmitted on the line pair by the termination unit.

7. The method of claim 6, wherein performing the signal loop tests comprises performing at least a signal attenuation test, a signal spectral shape test, and a longitudinal balance test.

8. The method of claim 1, wherein sending the initiate test signal comprises sending the signal to the termination unit over a digital subscriber line (xDSL) link.

9. The method of claim 1, wherein sending the initiate test signal comprises sending the signal over an embedded operations channel (EOC).

10. The method of claim 1, wherein sending the initiate test signal comprises sending the signal from a remote termination unit to the termination unit.

11. The method of claim 10, further comprising coupling a test set adapted to perform copper qualifying line testing to the remote termination unit to send the initiate test signal.

12. The method of claim 11, further comprising:
disconnecting the remote termination unit from the line pair; and
connecting the test set directly to the line pair before performing the series of line qualifying tests.

13. The method of claim 10, further comprising coupling a test set adapted to perform copper qualifying line testing to the remote termination unit by a video terminal 100 (VT100) connection.

14. The method of claim 1, further comprising:
disconnecting a remote termination unit from the line pair, if installed; and
connecting a test set adapted to perform copper qualifying line testing and equipped with an x digital subscriber line (xDSL) type modem to the line pair.

15. The method of claim 14, wherein the xDSL type modem is integrated into the test set.

16. The method of claim 14, wherein sending the initiate test signal comprises sending the signal to the termination unit via a non-xDSL type communication link.

17. The method of claim 14, wherein sending the initiate test signal comprises sending the signal to the termination unit over the line pair.

18. The method of claim 1, further comprising removing battery from the line pair before performing the series of line pair qualifying tests.

19. The method of claim 1, further comprising establishing an xDSL link in response to the line pair passing the series of line pair qualifying tests.

20. A method to qualify a line pair, comprising:
coupling a test set adapted to perform a series of qualification tests to a line pair; and
using a terminating unit (HTU) as a far-end device to perform the series of qualification tests in coordination with the test set.

21. The method of claim 20, further comprising sending an initiate test signal to the HTU, wherein the HTU is adapted to provide selected types of terminations connectable to the line pair in response to receiving the initiate test signal.

22. The method of claim 21, wherein sending the initiate test signal comprises sending the signal to the HTU over an x digital subscribe line (xDSL) link.

23. The method of claim 21, wherein sending the initiate test signal comprises sending the signal over an embedded operations channel (EOC).

24. The method of claim 21, wherein the HTU is a central office termination unit and wherein sending the initiate test signal comprises:
connecting the test set to a remote termination unit (HTU-R) to send the initiate test signal to the (HTU-C);
and wherein the method further includes:
disconnecting the HTU-R from the line pair after sending the initiate test signal; and
connecting the test set directly to the line pair after disconnecting the HTU-R and before performing the series of line qualifying tests.

25. The method of claim 21, wherein the test set is coupled to a subscriber end of the line pair by an xDSL type modem to send the initiate test signal.

26. The method of claim 21, wherein sending the initiate test signal comprises sending the signal to the HTU via a non-xDSL communication link.

27. The method of claim 20, wherein using the HTU comprises:
selectively open circuiting the line pair for a predetermined time period or in response to receiving a predetermined signal; and
performing open circuit line test on the line pair while the line pair is open circuited by the HTU.

28. The method of claim 20, wherein using the HTU comprises:
selectively short circuiting the line pair for a predetermined time period or in response to receiving a predetermined signal; and
performing short circuit line tests while the line pair is short circuited by the HTU.

29. The method of claim 20, wherein using the HTU comprises:
selectively transmitting a selected signal on the line pair for a predetermined time period or in response to receiving a predetermined signal; and
performing signal loop test while the selected signal is transmitted on the line pair by the HTU.

30. The method of claim 20, wherein the HTU is a remote termination unit (HTU-R) at a subscriber end of the line pair and wherein the test set is coupled to the line pair at a central office.

31. A method to qualify a line pair, comprising:
coupling a far end device to the line pair to perform selected line qualification tests; and
coupling a termination unit to the line pair by the far end device to perform other selected line qualification test.

32. The method of claim 31, further comprising transmitting signals from a test set to control operating of the far end device to connect the termination unit to the line pair.

33. The method of claim 31, further comprising transmitting signals from a test set to control operation of the far end device and the termination unit to perform different line qualification tests.

34. The method of claim 31, further comprising coupling the line pair to a common ground to perform resistive balance testing of the line pair.

35. The method of claim 34, further comprising operating input relays of the termination unit to connect the line pair to the common ground.

36. The method of claim 35, wherein the input relays are operated in response to a signal from a test set.

37. A system to qualify a line pair, comprising:
a test set adapted to perform a series of qualification tests on the line pair; and
a terminating unit (HTU) adapted to selectively provide different types of terminations connectable to the line pair to perform the series of qualifying tests on the line pair.

38. The system of claim 37, wherein the HTU is adapted to selectively connect an open circuit to the line pair for a predetermined time period or in response to receiving a predetermined signal and the test set is adapted to perform a plurality of open circuit tests while the line pair is open circuited by the HTU.

39. The system of claim 38, wherein the plurality of open circuit tests comprises time domain reflectometer tests, a signal leakage test, capacitive measurements, noise tests, a foreign voltage presence test, and an insulation resistance test.

40. The system of claim 37, wherein the HTU is adapted to selectively connect a short circuit to the line pair for a predetermined time period or in response to a predetermined signal and the test set is adapted to perform a plurality of short circuit tests while the line pair is short circuited by the HTU-C.

41. The system of claim 40, wherein the plurality of short circuit tests comprises a loop resistance measurement, ambient noise measurement, and a resistive balance test.

42. The system of claim 37, wherein the HTU is adapted to selectively connect a selected signal for transmission on the line pair and the test set is adapted to perform a plurality of signal loop tests while the selected signal is being transmitted on the line pair.

43. The system of claim 42, wherein the signal loop tests comprise a signal attenuation test, a signal spectral shape test, and a longitudinal balance test.

44. The system of claim 37, further comprising an initiate test signal, wherein the HTU selectively connects the different types of terminations to the line pair in response to receiving the initiate test signal.

45. The system of claim 44, wherein the initiate test signal is sent over an x digital subscriber line (xDSL) link to the HTU.

46. The system of claim 44, wherein the HTU is a central office termination unit (HTU-C), and wherein the system further comprises a remote termination unit (HTU-R), wherein the test set is connectable to the HTU-R to send the initiate test signal to the HTU-C.

47. The system of claim 46, further comprising a VT100 connection to connect the test set to the HTU-R.

48. The system of claim 44, wherein the initiate test signal is sent over an embedded operations channel (EOC).

49. The system of claim 44, wherein the initiate test signal is sent via a non-xDSL type communication link.

50. The system of claim 49, wherein the initiate test signal is sent over the line pair.

51. The system of claim 37, further comprising an xDSL type modem connectable between the test set and the line pair.

52. The system of claim 51, wherein the xDSL type modem is integrated into the test set.

53. The system of claim 37, wherein the HTU comprises a microprocessor adapted to control operation of the HTU to perform the qualification tests.

54. The system of claim 37, wherein the HTU is a remote HTU (HTU-R) at a subscriber end of the line pair.

55. The system of claim 37, wherein the HTU is a central office HTU (HTU-C) at a central office end of the line pair.

56. A system to qualify a line pair, comprising:
a far end device to perform line qualification tests; and
a termination unit, wherein the far end device is adapted to connect the termination unit to the line pair to perform the line qualifications tests.

57. The system of claim 56, further comprising a test set, wherein the far end device connects the termination unit to the line pair in response to a signal from the test set.

58. The system of claim 56, further comprising a test set to control operation of the far end device and the termination unit and to perform the line qualification tests.

59. The system of claim 56, further comprising a common ground connectable to the line pair to perform resistive balance testing.

60. The system of claim 59, wherein the termination unit comprises input relays, wherein the input relays are operable to connect the line pair to the common ground.

61. The system of claim 60, further comprising a test set, wherein the input relays are operable in response to a signal from the test set.

62. A termination unit (HTU), comprising:
a set of switches; and
a microprocessor to operate the switches to selectively connect different types of terminations to a line pair to perform qualifying tests on the line pair.

63. The HTU of claim 62, wherein the microprocessor is adapted to operate the switches to open circuit the line pair for a predetermined time period for open circuit line qualifying tests to be performed.

64. The HTU of claim 62, further comprising a transformer, wherein the microprocessor is adapted to operate the switches to connect the line pair to the transformer for a predetermined time period for short circuit line qualifying tests to be performed on the line pair.

65. The HTU of claim 62, further comprising a source to provide a selected signal, wherein the microprocessor is adapted to operate the switches to couple the line pair to the source of the selected signal for a predetermined time period for signal loop line qualifying tests to be performed on the line pair.

66. The HTU of claim 62, wherein the microprocessor operates the switches to selectively connect different types of terminations to the line pair in response to receiving an initiate test signal.

67. The HTU of claim 62, wherein the microprocessor operates the switches to selectively switch from one termination to another in response to receiving a predetermined signal over the line pair.

68. The HTU of claim 62, wherein the HTU is a central office termination unit (HTU-C).

69. The HTU of claim 62, wherein the HTU is a remote termination unit (HTU-R).

70. A test set to qualify a line pair, comprising:
a microprocessor to perform line qualifying tests; and
an xDSL type modem to signal a termination unit (HTU) to selectively connect different types of terminations to the line pair to perform the line qualifying tests.

71. The test set of claim 70, further comprising a memory to store results of the line qualification tests.

72. The test set of claim 70, wherein the xDSL modem is adapted to signal the HTU to connect one of an open circuit, a short circuit or a selected signal to the line pair for line qualification tests.

73. A method of making an HTU, comprising:
providing a microprocessor; and
providing instructions executable by the microprocessor to perform line qualification tests on a line pair.

74. The method of claim 73, further comprising providing a set of switches operable by the microprocessor in response to the instructions to couple different types of terminations to the line pair for qualification testing.

75. The method of claim 73, wherein providing the instructions comprises providing instructions to connect the line pair to an open circuit for open circuit line qualifying tests to be performed.

76. The method of claim 73, wherein providing the instructions comprises providing instructions to connect the line pair to a short circuit for short circuit line qualifying tests to be performed.

77. The method of claim 73, wherein providing instructions comprises providing instructions to connect the line pair to a selected signal for signal loop line qualifying tests to be performed.

78. A method of making a test set, comprising:
providing a microprocessor to perform line qualifying tests; and
providing an xDSL type modem to signal a termination unit (HTU) to selectively connect different types of terminations to the line pair to perform the line qualifying tests.

79. The method of claim 78, further comprising providing a memory to store results of the line qualification tests.

80. The method of claim 78, further comprising adapting the xDSL type modem to signal the HTU to connect one of an open circuit, a short circuit or a selected signal to the line pair for line the qualifying tests.
